(19) United States
(12) Patent Application Publication
(10) Pub. No.: US 2026/0279290 A1
(43) Pub. Date: Sep. 17, 2026

(54) PIXEL AND ELECTRONIC DEVICE

(71) Applicant: Samsung Display Co., LTD., Yongin-si (KR)

(72) Inventors: Mungyu KIM, Yongin-si (KR); Chankeun KWON, Yongin-si (KR); Junsoo KO, Yongin-si (KR); Hyungseup KIM, Yongin-si (KR)

(21) Appl. No.: 19/386,683

(22) Filed: Nov. 12, 2025

(30) Foreign Application Priority Data
Mar. 17, 2025 (KR) 10-2025-0034056

(51) Int. Cl. G09G 3/3275

(52) U.S. Cl. CPC G09G 3/3275; G09G 2330/021

(57) ABSTRACT

An electronic device includes a display panel and a data driving circuit. The display panel includes a plurality of pixels, and the data driving circuit provides a plurality of data signals to the plurality of pixels via a plurality of data lines, and provides a plurality of enable signals to the plurality of pixels via a plurality of enable lines. When a corresponding enable signal of the plurality of enable signals is at an active level, each of the plurality of pixels emits light in response to a corresponding data signal of the plurality of data signals.

### CROSS-REFERENCE TO RELATED APPLICATION

This application claims priority to Korean Patent Application No. 10-2025-0034056, filed on Mar. 17, 2025, and all the benefits accruing therefrom under 35 U.S.C. §119, the content of which in its entirety is herein incorporated by reference.

### BACKGROUND

### 1. Field

The present disclosure relates to a pixel of displaying an image and an electronic device including the pixel.

### 2. Description of the Related Art

An electronic device such as a television, a mobile phone, a tablet computer, a navigation system, a game machine, or the like generates an image and provides the generated image to a user via a display screen.

The electronic device includes a plurality of pixels and driving circuits that control an image to be displayed in the plurality of pixels. Each of the plurality of pixels includes a light-emitting element and transistors that control the light-emitting element.

### SUMMARY

The present disclosure provides a pixel and an electronic device capable of reducing power consumption.

According to an embodiment of the present disclosure, an electronic device includes a display panel and a data driving circuit. In such an embodiment, the display panel includes a plurality of pixels, and the data driving circuit provides a plurality of data signals to the plurality of pixels via a plurality of data lines, and provides a plurality of enable signals to the plurality of pixels via a plurality of enable lines. In such an embodiment, each of the plurality of pixels emits light in response to a corresponding data signal of the plurality of data signals when a corresponding enable signal of the plurality of enable signals is at an active level.

In an embodiment, each of the plurality of pixels may include a first transistor, an enable transistor, a second transistor and a light-emitting element. In such an embodiment, the first transistor may include a first electrode, a second electrode and a gate electrode. In such an embodiment, the enable transistor may include a first electrode connected to a corresponding data line of the plurality of data lines, a second electrode, and a gate electrode which receives the corresponding enable signal of the plurality of enable signals. In such an embodiment, the second transistor may include a first electrode connected to the second electrode of the enable transistor, a second electrode connected to the first electrode of the first transistor, and a gate line which receives a scan signal. In such an embodiment, the light-emitting element may be electrically connected to the second electrode of the first transistor.

In an embodiment, when both the enable transistor and the second transistor are turned on, a data signal applied to the corresponding data line may be transferred to the first electrode of the first transistor.

In one embodiment, the plurality of enable signals may respectively correspond to the plurality of data lines, and when the data signal is transferred to a corresponding data line of the plurality of data line, each of the plurality of enable signal may be at an active level.

In an embodiment, each of the plurality of data lines may extend in a first direction and may be spaced apart in a second direction intersecting the first direction, and the display panel may include a still image display area and a moving image display area which are sequentially arranged in the second direction.

In an embodiment, the data driving circuit may provide the data signal to a pixel disposed in the still image display area among the plurality of pixels during a first frame, and may not provide the data signal to the pixel disposed in the still image display area among the plurality of pixels during a second frame.

In an embodiment, when the data driving circuit does not provide the data signal to a pixel disposed in the still image display area among the plurality of pixels, the data driving circuit may maintain the corresponding enable signal provided to the pixel disposed in the still image display area at an inactive level.

In an embodiment, when the data driving circuit provides the data signal to a pixel disposed in the moving image display area among the plurality of pixels, the data driving circuit may maintain the corresponding enable signal provided to the pixel disposed in the moving image display area at an active level.

In an embodiment, the pixel disposed in the still image display area of the display panel may be driven at a first driving frequency, and the pixel disposed in the moving image display area of a display panel may be driven at a second driving frequency higher than the first driving frequency.

In an embodiment, the display panel may include a first display area and a second display area which are sequentially arranged in the first direction, the second display area may include the still image display area and the moving image display area, the pixels arranged in the first display area and the still image display areas of the display panel may be driven at a first driving frequency, and the pixels arranged in the moving image display area of the display panel may be driven at a second driving frequency higher than the first driving frequency.

An electronic device according to an embodiment of the present disclosure includes a processor and a display module. In such an embodiment, the processor provides an input image signal and a control signal, and the display module displays an image in a multi-frequency mode in response to the input image signal and the control signal. In such an embodiment, the display module includes a display panel, a driving controller and a data driving circuit. In such an embodiment, the display panel includes a plurality of pixels. In such an embodiment, the driving controller outputs an output image signal and a data control signal in response to the input image signal and the control signal. In such an embodiment, the data driving circuit provides a plurality of data signals to the plurality of pixels via a plurality of data lines, and provides a plurality of enable signals to the plurality of pixels via the plurality of enable lines, in response to the output image signal and the data control signal. In such an embodiment, each of the plurality of pixels emits light in response to a corresponding data signal of the plurality of data signals when a corresponding enable signal of the plurality of enable signals is at an active level.

In an embodiment, each of the plurality of pixels may include a first transistor, an enable transistor, a second transistor and a light-emitting element. In such an embodiment, the first transistor may include a first electrode, a second electrode, and a gate electrode. In such an embodiment, the enable transistor may include the first electrode connected to a corresponding data line of the plurality of data lines, the second electrode, and a gate electrode which receives the corresponding enable signal of the plurality of enable signals. In such an embodiment, the second transistor may include a first electrode connected to the second electrode of the enable transistor, a second electrode connected to the first electrode of the first transistor, and a gate line which receives a scan signal. In such an embodiment, the light-emitting element is electrically connected to the second electrode of the first transistor.

In an embodiment, when both the enable transistor and the second transistor are turned on, a data signal applied to the corresponding data line may be transferred to the first electrode of the first transistor.

In an embodiment, the plurality of enable signals may respectively correspond to the plurality of data lines, and when the data signal is transferred to a corresponding data line of the plurality of data line, each of the plurality of enable signal may be at an active level.

In an embodiment, each of the plurality of data lines may extend in a first direction and may be spaced apart in a second direction intersecting the first direction, and the display panel may include a still image display area and a moving image display area which are sequentially arranged in the second direction.

In an embodiment, when the data driving circuit does not provide the data signal to a pixel disposed in the still image display area among the plurality of pixels, the data driving circuit may maintain the corresponding enable signal provided to the pixel disposed in the still image display area at an inactive level.

In an embodiment, when the data driving circuit provides the data signal to a pixel disposed in the moving image display area among the plurality of pixels, the data driving circuit may maintain the corresponding enable signal provided to the pixel disposed in the moving image display area at an active level.

A pixel according to an embodiment of the present disclosure includes a first transistor, an enable transistor, a second transistor and a light-emitting element. In such an embodiment, the first transistor includes a first electrode, a second electrode, and a gate electrode. In such an embodiment, the enable transistor includes a first electrodes connected to a data line which transfers a data signal, a second electrode and a gate electrode which receives an enable signal. In such an embodiment, the second transistor includes a first electrode connected to the second electrode of the enable transistor, a second electrode connected to the first electrode of the first transistor, and a gate line which receives a scan signal. In such an embodiment, the light-emitting element is electrically connected to the second electrode of the first transistor.

In an embodiment, when the data signal is transferred to the data line, the enable signal may be at an active level.

In an embodiment, when both the enable transistor and the second transistor are turned on, the data signal may be transferred to the first electrode of the first transistor.

### BRIEF DESCRIPTION OF DRAWINGS

FIG. 1 is a block diagram of an electronic device according to an embodiment of the present disclosure.

FIG. 2 is a schematic diagram of electronic devices according to various embodiments of the present disclosure.

FIG. 3A illustrates an electronic device according to an embodiment of the present disclosure.

FIG. 3B illustrates a second display area of the electronic device illustrated in FIG. 3A.

FIGS. 4A and 4B are perspective views of an electronic device according to an embodiment of the present disclosure.

FIG. 5A is a diagram for describing an operation of an electronic device in a single frequency mode.

FIG. 5B is a diagram for describing an operation of an electronic device in a multi-frequency mode.

FIG. 6 is a block diagram of a display module according to an embodiment of the present disclosure.

FIG. 7 is a circuit diagram of a pixel according to an embodiment of the present disclosure.

FIG. 8 illustrates scan signals in the single frequency mode and the multi frequency mode.

FIG. 9 illustrates scan signals in the single frequency mode and the multi frequency mode.

FIG. 10 illustrates enable signals in the single frequency mode and the multi frequency mode.

FIG. 11 is a signal timing diagram illustrating enable signals according to an embodiment of the present disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

In this specification, it will be understood that when a component (or a region, a layer, a portion, or the like) is referred to as being “connected to” or “coupled to” another component, it can be directly connected to, or coupled to a third component may be disposed therebetween.

Like reference numerals refer to like components. In addition, in the drawings, thicknesses, ratios, and dimensions of the components are exaggerated for effective description of the technical content.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless defined otherwise, all terms (including technical and scientific terms) used herein have the same meaning as commonly understood by one of ordinary skill in the art to which this disclosure belongs. In addition, terms such as those defined in commonly used dictionaries should be interpreted as having a meaning that is consistent with their meaning in the context of the relevant art, and should not be interpreted in an idealized or overly formal sense unless explicitly defined herein.

Hereinafter, embodiments of the present disclosure will be described with reference to the accompanying drawings.

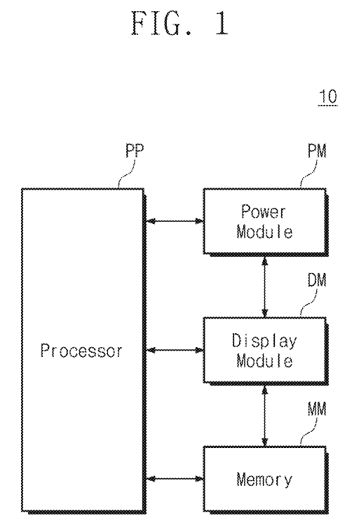

FIG. 1 is a block diagram of an electronic device 10 according to an embodiment of the present disclosure.

Referring to FIG. 1, an electronic device 10 according to an embodiment may include a display module DM, a processor PP, a memory MM, and a power supply module PM.

The processor PP may include at least one selected from a central processing unit (CPU), an application processor (AP), a graphic processing unit (GPU), a communication processor (CP), an image signal processor (ISP), and a controller.

The memory MM may store data information used for operations of the processor PP or the display module DM. When the processor PP executes an application stored in the memory MM, an image data signal and/or an input control signal are transferred to the display module DM, and the display module DM may process the received signal to output image information through a display screen.

The power supply module PM may include a power supply module such as a power adapter or a battery device, and a power conversion module that converts power supplied by the power supply module to generate power used for operation of the electronic device 10.

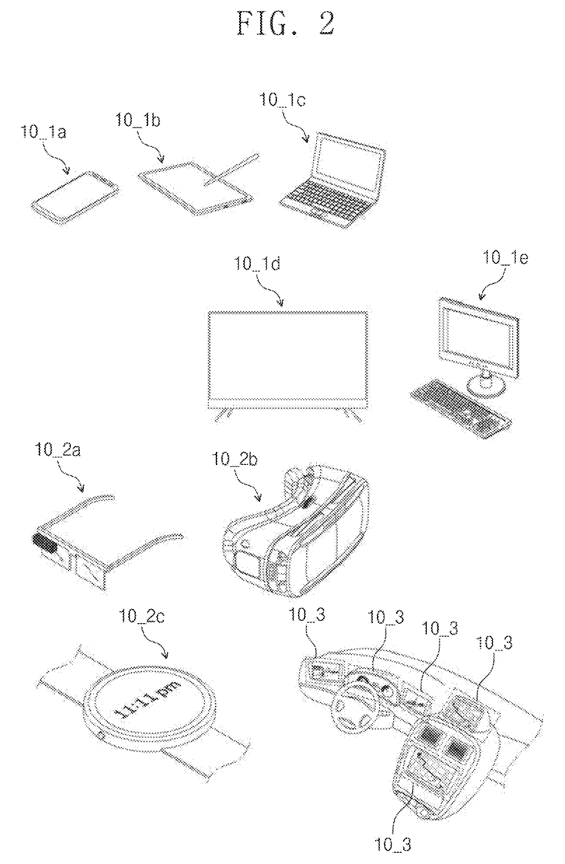

FIG. 2 is a schematic diagram of electronic devices according to various embodiments of the present disclosure.

Referring to FIG. 2, electronic devices according to various embodiments may include an electronic device for displaying an image such as a smartphone 10_1a, a tablet personal computer (PC) 10_1b, a laptop computer 10_1c, a television (TV) 10_1d, and a desk monitor 10_1e, a wearable electronic device including a display module such as smart glasses 10_2a, a head mounted display 10_2b, a smart watch 10_2c, and the like, and an electronic device for a vehicle 10_3 including a display module, such as a center information display (CID) and a room mirror display disposed on an instrument panel, a center fascia, and a dashboard of a vehicle, and the like.

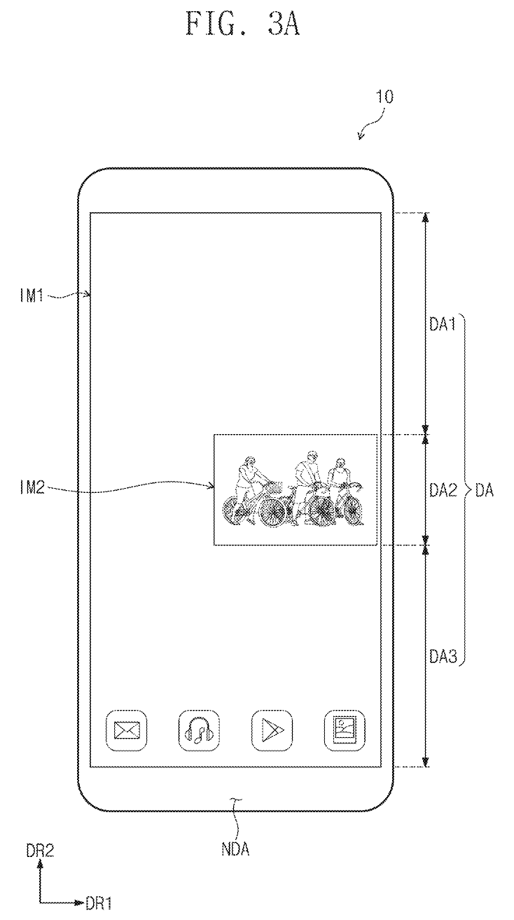

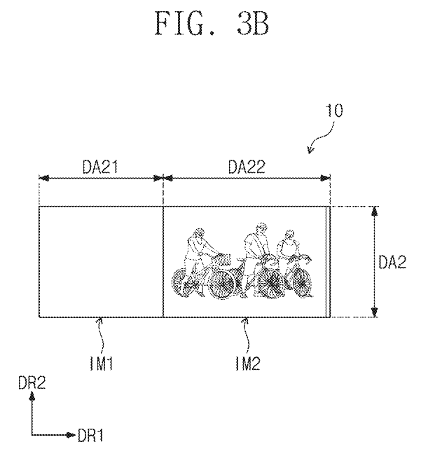

FIG. 3A illustrates an electronic device 10 according to an embodiment of the present disclosure.

Referring to FIG. 3A, an electronic device 10 according to an embodiment of the present disclosure may be a portable terminal, for example. The portable terminal may include a tablet computer, a smartphone, a personal digital assistant (PDA), a portable multimedia player (PMP), a game machine, a wrist-watch-type electronic device, and the like. However, the present disclosure is not limited thereto. Embodiments of the present disclosure may be used in large electronic equipment such as televisions or external billboards, as well as small and medium-sized electronic equipment such as PCs, laptop computers, kiosks, car navigation units, cameras, and the like. These are merely examples, and may be employed in other electronic devices without departing from the present disclosure of the present disclosure.

In an embodiment, as illustrated in FIG. 3A, a display surface of the electronic device 10 on which the first image IM1 and the second image IM2 are displayed is parallel to a surface on a plane defined by a first direction DR1 and a second direction DR2. The electronic device 10 includes a plurality of regions divided on the display surface. The display surface includes a display area DA in which the first image IM1 and the second image IM2 are displayed, and a non-display area NDA adjacent to the display area DA. The non-display area NDA may be referred to as a bezel area. in an embodiment, for example, the display area DA may have a rectangular shape in a plan view. The non-display area NDA surrounds the display area DA in the plan view. Further, although not illustrated, as an example, the electronic device 10 may include a partially curved shape.

The display area DA of the electronic device 10 includes a first display area DA1, a second display area DA2 and a third display area DA3. The first display area DA1, the second display area DA2 and the third display area DA3 may be sequentially disposed in a direction opposite to the second direction DR2.

In a specific application program, the first image IM1 may be displayed in all of the first display area DA1 and the third display area DA3 and a part of the second display area DA2, and the second image IM2 may be displayed in another part of the first display region DA2. In an embodiment, for example, the first image IM1 may be an image having a long change period (for example, a still image such as a photograph or text information), and the second image IM2 may be an image (for example, a moving image) having a short change period.

The operation mode of the electronic device 10 may include a single frequency mode and a multi-frequency mode. During the single frequency mode, the electronic device 10 may drive all of the first display area DA1, the second display area DA2, and the third display area DA3 at a predetermined frequency or a basis frequency. During the multi-frequency mode, the electronic device 10 according to an embodiment may drive the first display area DA1 and the third display area DA3 in which the first image IM1 is displayed at a first driving frequency and drive the second display area DA2 in which the second image IM2 is displayed at a second driving frequency different from the first frequency. In an embodiment, the first driving frequency may be lower than or equal to the basis frequency. In an embodiment, the second driving frequency may be higher than the first driving frequency. In an embodiment, the second driving frequency may be higher than or equal to the basis frequency. The electronic device 10 may reduce power consumption by lowering driving frequencies of the first display area DA1 and the third display area DA3 in which the still image is displayed. The electronic device 10 may improve display quality by maintaining a high driving frequency of the second display area DA2 in which a moving image is displayed.

A size and a position of each of the first display area DA1, the second display area DA2 and the third display area DA3 may be predetermined, and may be changed (or variously determined) by selections of an application program or a user.

In an embodiment, the display area DA may be divided into two or more display areas, and a driving frequency of each of the display areas may be determined according to a type of an image (for example, a still image or a moving image) displayed in each of the display areas.

FIG. 3B illustrates a second display area DA2 of the electronic device 10 illustrated in FIG. 3A.

Referring to FIG. 3B, the second display area DA2 of the electronic device 10 includes a still image display area DA21 and a moving image display area DA22.

In an embodiment, as illustrated in FIG. 3B, the still image display area DA21 and the moving image display area DA22 may be sequentially arranged in the first direction DR1, but the present disclosure is not limited thereto.

The first image IM1, that is, the still image, may be displayed in the still image display area DA21, and the second image IM2, that is, the moving image, may be display in the moving image display area DA22.

The electronic device 10 according to an embodiment may drive the still image display area DA21 in which the first image IM1 is displayed in the second display area DA2 during the multi-frequency mode at a first driving frequency, and drive the moving image display area DA22 in the second display area DA2 at a second driving frequency. In an embodiment, the first driving frequency may be lower than or equal to the basis frequency. In an embodiment, the second driving frequency may be higher than or equal to the basis frequency. In an embodiment, the second driving frequency may be higher than the first driving frequency.

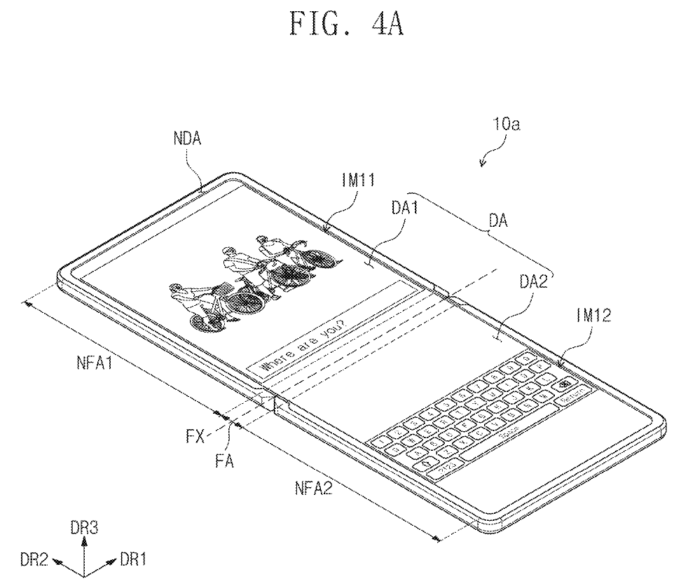

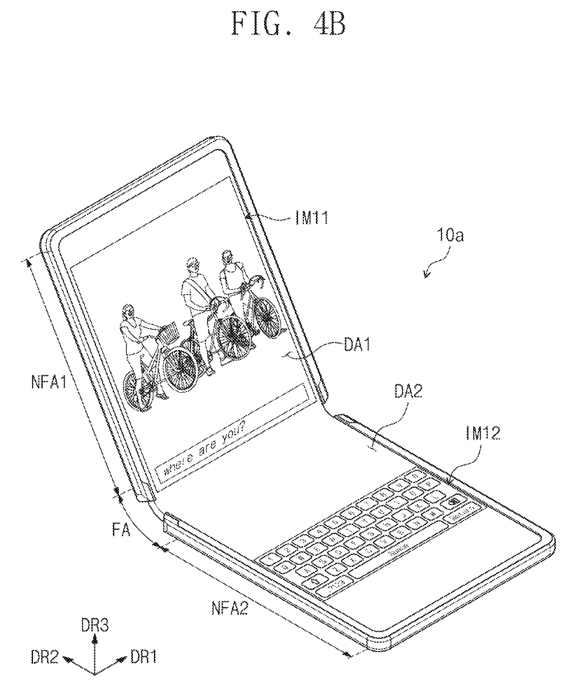

FIGS. 4A and 4B are perspective views of an electronic device 10a according to an embodiment of the present disclosure. FIG. 4A illustrates the electronic device 10a in a state where the electronic device 10a is unfolded, and FIG. 4B illustrates the electronic device 10a in a state where the electronic devices 10a is folded.

In an embodiment, as illustrated in FIGS. 4A and 4B, the electronic device 10a includes a display area DA and a non-display area NDA. The electronic device 10a may display an image in the display area DA. In a state where the electronic device 10a is unfolded, the display area DA may include a plane defined by the first direction DR1 and the second direction DR2. The thickness direction of the electronic device 10a may be parallel to a third direction DR3 intersecting the first direction DR1 and the second direction DR2. Therefore, the front surface (or the upper surface) and the rear surface (or the lower surface) of the components constituting the electronic device 10a may be defined with reference to the third direction DR3. The non-display area NDA may be referred to as a bezel area. In an embodiment, for example, the display area DA may have a rectangular shape in a plan view (or when viewed in the third direction DR3). The non-display area NDA surrounds the display area DA in the plan view.

The display area DA may include a first non-folding area NFA1, a folding area FA and a second non-folding areas NFA2. The folding region FA may be bent with respect to the folding axis FX extending along the first direction DR1.

When the electronic device 10a is folded, the first non-folding region NFA1 and the second non-folding area NFA2 may face each other. Thus, in the state where the electronic device 10a is fully folded, the display area DA may not be exposed to the outside, which may be referred to as in-folding. However, this is an example embodiment, and the operation of the electronic device 10a is not limited thereto.

In an embodiment of the present disclosure, when the electronic device 10a is folded, the first non-folding region NFA1 and the second non-folding area NFA2 may be opposed to each other. Thus, in the state where the electronic device 10a is folded, the first non-folding region NFA1 may be exposed to the outside, which may be referred to as out-folding.

The electronic device 10a may only be capable of either in-folding operation or out-folding operation. Alternatively, the electronic device 10a may be capable of both an in-folding operation and an out-folding operation. In such an embodiment, a specific area of the electronic device 10a, for example, the folding area FA, may be in-folded and out-folded. Alternatively, some areas of the electronic device 10a may be in-folded, and some other areas may be out-folded.

Although an embodiment where one folding area and two non-folding areas are provided is illustrated in FIGS. 4A and 4B as an example, the number of the folding area and the non-folding region is not limited thereto. In another embodiment, for example, the electronic device 10a may include more than two non-folding areas and a plurality of folding areas disposed between non-folding areas adjacent to each other.

Although FIGS. 4A and 4B illustrate an embodiment where the folding axis FX is parallel to the minor axis of the electronic device 10a, the present disclosure is not limited thereto. In another embodiment, for example, the folding axis FX may extend along the major axis of the electronic device 10a, for example, a direction parallel to the second direction DR2.

Although FIGS. 4A and 4B illustrate an embodiment where the first non-folding region NFA1, the folding region FA, and the second non-folding area NFA2 are sequentially arranged along the second direction DR2, the present disclosure is not limited thereto. In another embodiment, for example, the first non-folding region NFA1, the folding region FA, and the second non-folding area NFA2 may be sequentially arranged along the first direction DR1.

A plurality of display areas DA1 and DA2 may be defined in the display area DA of the electronic device 10a. Although an embodiment where two display areas DA1 and DA2 are provided is illustrated as an example in FIG. 4A, the number of the plurality of display areas DA1 or DA2 is not limited thereto.

The plurality of display areas DA1 and DA2 may include a first display area DA1 and a second display area DA2. In an embodiment, for example, the first display area DA1 may be an area where an eleventh image IM11 is displayed, and the second display area DA2 may be an area where a twelfth image IM12 is displayed. In an embodiment, for example, the eleventh image IM11 may be a moving image, and the twelfth image IM12 may be a still image.

The electronic device 10a according to an embodiment may operate differently depending on an operation mode. The operation mode of the electronic device 10a may include a single frequency mode and a multi-frequency mode.

The electronic device 10a may drive both the first display area DA1 and the second display area DA2 at a basis frequency during the single frequency mode. The electronic device 10a according to an embodiment may drive the first display area DA1 where the eleventh image IM11 is displayed at a first driving frequency and drive the second display area DA2 where the twelfth image IM12 is displayed at a second driving frequency during the multi-frequency mode. In an embodiment, the first driving frequency may be higher than or equal to the basis frequency, and the second driving frequency may be lower than the basis frequency.

The size of each of the first display area DA1 and the second display area DA2 may be a predetermined size and may be changed (or variously determined) by an application program. In an embodiment, the first display area DA1 may correspond to the first non-folding area NFA1, and the second display area DA2 may correspond to the second non-folding areas NFA2. In addition, a first part of the folding area FA may correspond to the first display area DA1, and a second part of the folding area FA may correspond to the second display area DA2.

In an embodiment, all of the folding areas FA may correspond to only one of the first display area DA1 and the second display area DA2.

In an embodiment, the first display area DA1 may correspond to a first part of the first non-folding area NFA1, and the second display area DA2 may correspond to a second part of the first non-folding area NFA1, the folding area FA, and the second non- folding area NFA2. In such an embodiment, the area of the second display area DA2 may be larger than the area of the first display area DA1.

In an embodiment, the first display area DA1 may correspond to a first part of the first non-folding area NFA1, the folding area FA, and the second non-folding region NFA2, and the second display area DA2 may correspond to a second part of the second non-folding area NFA2. In such an embodiment, the area of the first display area DA1 may be larger than the area of the second display area DA2.

In an embodiment, as illustrated in FIG. 4B, in a state where the folding area FA is folded, the first display area DA1 may correspond to the first non-folding area NFA1, and the second display area DA2 may correspond to the folding areas FA and the second non-folding areas NFA2.

Although FIGS. 4A and 4B show an embodiment of an electronic device 10a having a single folding region as an example, the present disclosure is not limited thereto. In another embodiment, for example, the present disclosure may also be applied to an electronic device having two or more folding regions, a rollable electronic device, a slidable electronic device, or the like.

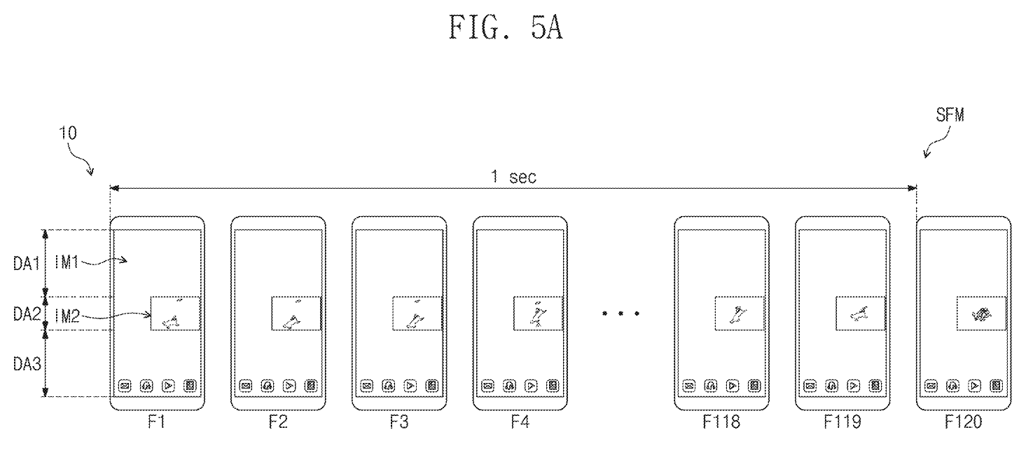

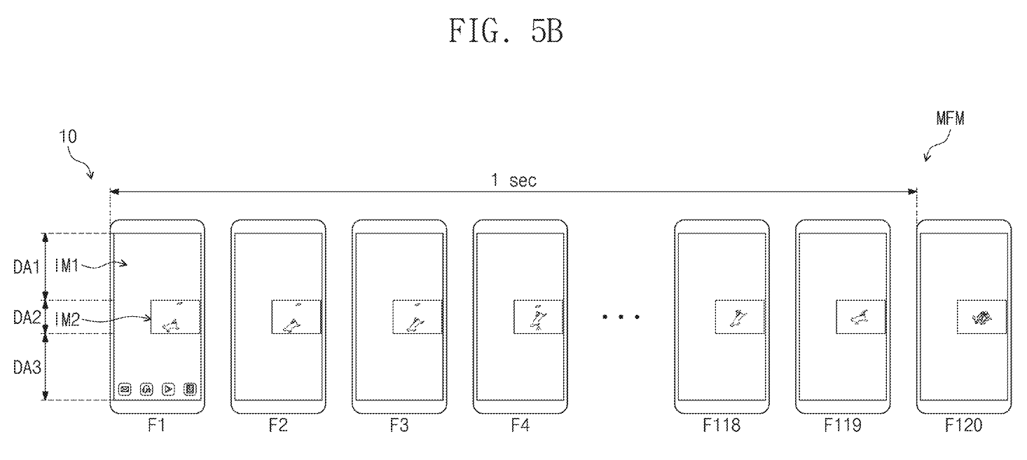

FIG. 5A is a diagram for explaining an operation of the electronic device 10 in the single frequency mode SFM.

FIG. 5B is a diagram for explaining an operation of the electronic device 10 in the multi-frequency mode MFM.

Referring to FIG. 5A, the first image IM1 displayed in all of the first display area DA1 and the third display area DA3 and a part of the second display area DA2 may be a still image or an image having a long change period, and the second image IM2 displayed in another part of the second displayed area DA2 may also be a moving image or an image having a short change period. The first image IM1 and the second image IM2 illustrated in FIG. 5A are merely examples, and various images may be displayed on the electronic device 10.

In the single frequency mode SFM, a driving frequency of the first display area DA1, the second display area DA2 and the third display area DA3 of the electronic device 10 is the basis frequency. In an embodiment, for example, the basis frequency may be 120 hertz (Hz). In the single frequency mode SFM, each of the first display area DA1, the second display area DA2 and the third display area DA3 of the electronic device 10 may be provided with a data signal corresponding to images of the first frame F1 to the 120th frame F120 for one second.

Referring to FIG. 5B, in the multi-frequency mode MFM, the electronic device 10 may set the driving frequency of all of the first display area DA1 and the third display area DA3 and a part of the second display area DA2 in which the first image IM1, that is, the still image is displayed, to be the first driving frequency, and set the driving frequency of another part of the second display area DA2 in which the second image IM2, that is, the moving image is displayed, to be the second driving frequency higher than the first driving frequency. In an embodiment, the first driving frequency may be 1 Hz and the second driving frequency may be 120 Hz. The first driving frequency and the second driving frequency may vary.

When the first driving frequency is 1 Hz and the second driving frequency is 120 Hz in the multi-frequency mode MFM, a data signal corresponding to the second image IM2 in each of the first frame F1 to the 120th frame F120 may be provided to another part of the second display area DA2 of the electronic device 10 for one second. A data signal corresponding to the first image IM1 only in the first frame F1 may be provided to all of the first display area DA1 and the third display area DA3 and a part of the second display area DA2. That is, in the second to 120th frames F2 to F120, a new data signal is not provided to all of the first display area DA1 and the third display area DA3 and a part of the second display area DA2, and thus the same first image IM1 as the first frame F1 may be displayed on the electronic device 10 during the second to 120th frames F2 to F120.

FIG. 5B illustrates a case where the first driving frequency is 1 Hz and the second driving frequency is 120 Hz in the multi-frequency mode MFM, but the present disclosure is not limited thereto. The first driving frequency may be variously changed to a frequency lower than the second driving frequency, for example, 60 Hz, 30 Hz, 10 Hz, or the like.

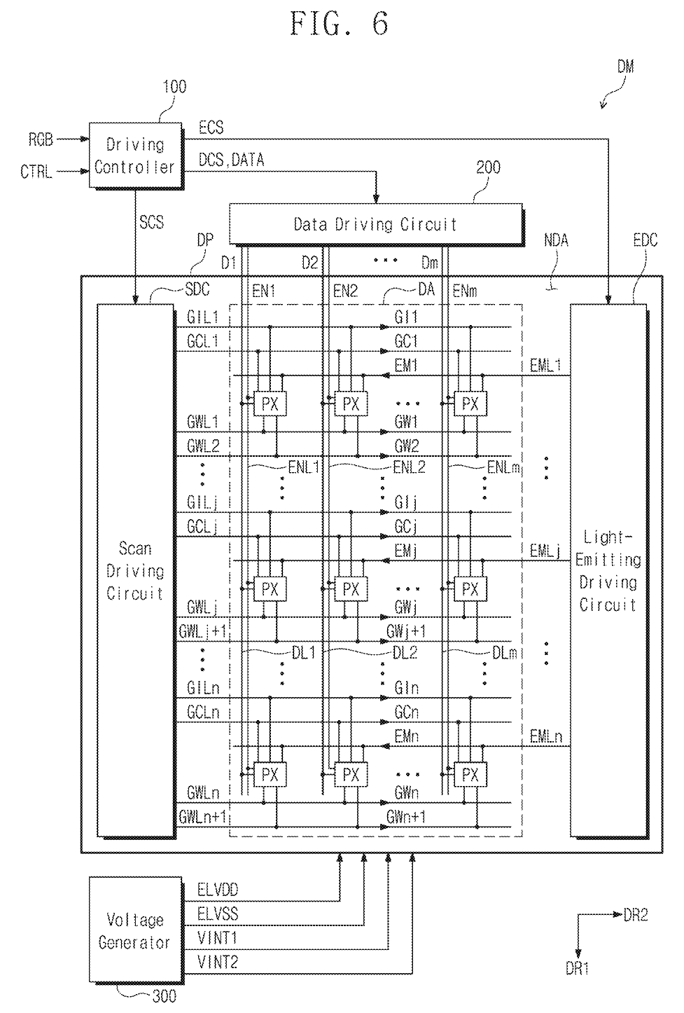

FIG. 6 is a block diagram of a display module DM according to an embodiment of the present disclosure.

Referring to FIG. 6, an embodiment of the display module DM includes a display panel DP, a driving controller 100, a data driving circuit 200, a voltage generator 300, a scan driving circuit SDC and a light-emitting driving circuit EDC.

The driving controller 100 receives an input image signal RGB and a control signal CTRL from an outside (or an external device). In an embodiment, the input image signal RGB and the control signal CTRL may be provided from the processor PP illustrated in FIG. 1. The driving controller 100 outputs an output image signal DATA, a scan control signal SCS, a data control signal DCS and a light emission control signal ECS corresponding to the input image signal RGB and the control signal CTRL.

The driving controller 100 according to an embodiment of the present disclosure may determine the operation mode to be one of a single frequency mode SFM and a multi-frequency mode MFM based on at least one selected from the input image signal RGB and the control signal CTRL. The driving controller 100 may output the output image signal DATA, the scan control signal SCS, the data control signal DCS and the light emission control signal ECS corresponding to the determined operation mode.

The display panel DP includes a display area DA and a non-display area NDA. The display panel DP may include pixels PX disposed in the display area DA. In an embodiment, the scan driving circuit SDC and the light-emitting driving circuit EDC may be disposed on the display panel DP.

The display panel DP includes scan lines GIL1 to GILn, GCL1 to GCLn and GWL1 to GWLn+1, emission control lines EML1 to EMLn, data lines DL1 to DLm, enable lines ENL1 to ENLm and pixels PX. Here, n and m are positive integers greater than 1.

The scan lines GIL1 to GILn, GCL1 to GCLn and GWL1 to GWLn+1 and the light emission control lines EML1 to EMLn are arranged to be spaced apart from each other in the first direction DR1. The data lines DL1 to DLm extend from the data driving circuit 200 in the first direction DR1 and are arranged to be spaced apart from each other in the second direction DR2. The enable lines ENL1 to ENLm extend from the data driving circuit 200 in the first direction DR1 and are arranged to be spaced apart from each other in the second direction DR2.

The data driving circuit 200 receives the data control signal DCS and the output image signal DATA from the driving controller 100. The data driving circuit 200 converts the output image signal DATA into data signals, and outputs the data signals D1 to Dm to a plurality of data lines DL1 to DLm to be described later. The data signals are analog voltages corresponding to a grayscale value of the output image signal DATA. In an embodiment, the data driving circuit 200 may output the enable signals EN1 to ENm. The enable signals EN1 to ENm may correspond to the data signals D1 to Dm, respectively.

In an embodiment, the data driving circuit 200 may minimize power consumed by the data driving circuits 200 by disabling some of the data lines DL1 to DLm (that is, data lines corresponding to the display area in which the still image is displayed) in some frames of the plurality of frames when the display area in which the still image of the display panel DP is displayed is driven. The data driving circuit 200 outputs some of the enable signals EN1 to ENm corresponding to the data lines to be disabled to a predetermined inactivity level (e.g., a high level).

The voltage generator 300 generates voltages used for operation of the display panel DP. In an embodiment, the voltage generator 300 generates the first driving voltage ELVDD, the second driving voltage ELVSS, the first initialization voltage VINT1 and the second initialization voltage VINT2.

The scan driving circuit SDC is arranged on a first side of the display panel DP. The scan lines GIL1 to GILn, GCL1 to GCLn and GWL1 to GWLn+1 extend from the scan driving circuit SDC in the second direction DR2. The light-emitting driving circuit EDC is arranged on a second side of the display panel DP. The light-emitting control lines EML1 to EMLn extend from the light-emitting driving circuit EDC in a direction opposite to the second direction DR2.

In an embodiment, as illustrated in FIG. 6, the scan driving circuit SDC and the light-emitting driving circuit EDC may be arranged to face each other with the display area DA in which the pixels PX are arranged interposed between the scan driving circuit SDC and the light-emitting driving circuit EDC, but the present disclosure is not limited thereto. In another embodiment, for example, the scan driving circuit SDC and the light-emitting driving circuit EDC may be disposed adjacent to each other on either the first side or the second side of the display panel DP. In another embodiment, the scan driving circuit SDC and the light-emitting driving circuit EDC may be configured as one circuit.

In an embodiment, each of the scan driving circuit SDC and the light-emitting driving circuit EDC is not disposed in the display panel DP and may be configured as a separate integrated circuit.

The plurality of pixels PX are electrically connected to the scan lines GIL1 to GILn, GCL1 to GCLn and GWL1 to GWLn+1, the light emission control lines EML1 to EMLn, the data lines DL1 to DLm and the enable lines EML1 to EMLn, respectively. In an embodiment, each of the plurality of pixels PX may be electrically connected to four scan lines and one light emission control line. In an embodiment, for example, as illustrated in FIG. 4, the pixels of the first row may be connected to the scan lines GIL1, GCL1, GWL1 and GWL2 and the light emission control line EML1. In addition, the pixels of the j-th row may be connected to the scan lines GILj, GCLj, GWLj and GWLj+1 and the light emission control line EMLj. The pixels of the n-th row may be connected to the scan lines GILn, GCLn, GWLn and GWLn+1 and the light emission control line EMLn.

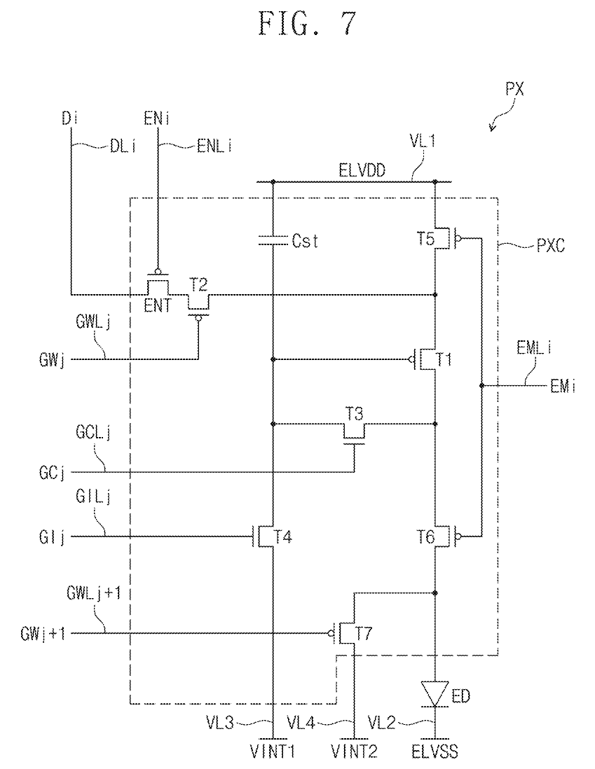

Each of the plurality of pixels PX includes a light-emitting element ED (see FIG. 7) and a pixel circuit PXC (see FIG. 7) that controls light emission of the light-emitting element. The pixel circuit PXC may include one or more transistors and one or more capacitors. The scan driving circuit SDC and the light-emitting driving circuit EDC may include transistors formed through a same process as the transistors in the pixel circuit PXC.

Each of the plurality of pixels PX receives a first driving voltage ELVDD, a second driving voltage ELVSS, a first initialization voltage VINT1 and a second initialization voltage VINT2 from the voltage generator 300.

The scan driving circuit SDC receives the scan control signal SCS from the driving controller 100. The scan driving circuit SDC may output the scan signals GI1 to GIn, GC1 to GCn and GW1 to GWn+1 to the scan lines GIL1 to GILn, GCL1 to GCLn and GWL1 to GWLn+1 in response to the scan control signal SCS.

The light-emitting driving circuit EDC receives the light-emitting control signal ECS from the driving controller 100. The light-emitting driving circuit EDC may output the light-emitting signals EM1 to EMn to the light-emitting control lines EML1 to EMLn in response to the light-emission control signal ECS.

The driving controller 100 according to an embodiment determines an operation mode based on the input image signal RGB. The driving controller 100 drives the display area DA at a basis frequency (for example, 120 Hz) when the determined operation mode is the single frequency mode.

When the determined operation mode is the multi-frequency mode, the driving controller 100 may divide the display panel DP into two or more display areas, and set the driving frequency of each of the display areas.

FIG. 7 is a circuit diagram of a pixel PX according to an embodiment of the present disclosure.

FIG. 7 illustrates the pixel PX connected to the i-th data line DLi among the data lines DL1 to DLm, the i-th enable line EMLi among the enable lines EL1 to ELm, the j-th scan lines GILj, GCLj and GWLj and the (j+1)-th scan line GWLj+1 among the scan lines GIL1 to GILn, GCL1 to GCLn and GWL1 to GWLn+1, and the j-th light emission control line EMLj among the light emission control lines EML1 to EMLn, illustrated in FIG. 6.

Each of the plurality of pixels PX illustrated in FIG. 6 may have a same circuit configuration as the pixel PX illustrated in FIG. 7. The pixel PX according to an embodiment includes a pixel circuit PXC and at least one light-emitting element ED. In an embodiment, the light-emitting element ED may be an organic light-emitting diode. The pixel circuit PXC includes first to seventh transistors T1, T2, T3, T4, T5, T6 and T7, an enable transistor ENT and a capacitor Cst.

In an embodiment, as shown in FIG. 7, among the first to seventh transistors T1 to T7 and the enable transistor ENT, the third and fourth transistors T3 and T4 are N-type transistors having an oxide semiconductor as a semiconductor layer, and each of the first, second, fifth, sixth, and seventh transistors T1, T2, T5, T6 and T7 and the enable transistor ENT is a P-type transistor having a low-temperature polycrystalline silicon (LTPS) semiconductor layer. However, the present disclosure is not limited thereto. In another embodiment, for example, all of the first to seventh transistors T1 to T7 and the enable transistor ENT may be P-type transistors or N-type transistors. In another embodiment, at least one of the first to seventh transistors T1 to T7 and the enable transistor ENT may be an N-type transistor, and the other thereof may be a P-type transistor. In addition, the circuit configuration of the pixel according to the present disclosure is not limited to that of FIG. 5. The pixel circuit PXC illustrated in FIG. 5 is merely an example, and the configuration of the pixel circuit PX C may be modified and implemented.

The j-th scan lines GILj, GCLj and GWLj may respectively transfer the j-th scan signals GIj, GCj and GWj, and the (j+1)-th scan line GWLj+1 may transfer the (j+1)-th scan signal GWj+1. The light emission control line EMLj transfers the light emission signal EMj, and the i-th data line DLi transfers the i-th data signal Di. The i-th enable line ENLi transfers the i-th enable signal ENi. The data signal Di may have a voltage level corresponding to the input image signal RGB input to the display module DM (see FIG. 6). The first to fourth driving voltage lines VL1, VL2, VL3 and VL4 may respectively transfer the first driving voltage ELVDD, the second driving voltage ELVSS, the first initialization voltage VINT1 and the second initialization voltage VINT2.

The first transistor T1 includes a first electrode connected to the first driving voltage line VL1 via a fifth transistor T5, a second electrode electrically connected to an anode of the light-emitting element ED via a sixth transistor T6, and a gate electrode connected to one end of the capacitor Cst. The first transistor T1 may receive the data signal Di transferred from the data line DLi based on switching operations of the enable transistor ENT and the second transistor T2 to supply a driving current to the light-emitting element ED.

The enable transistor ENT includes a first electrode connected to the data line DLi, a second electrode, and a gate electrode connected to the enable line ENLi.

The second transistor T2 includes a first electrode connected to the second electrode of the enable transistor ENT, a second electrode connected to the first electrode of the first transistor T1, and a gate electrode connected to the scan line GWLj. The second transistor T2 may be turned on in response to the scan signal GWj transferred via the scan line GWLj to transfer the data signal Di transferred from the data line DLi to the first electrode of the first transistor T1.

In an embodiment, when both the enable transistor ENT and the second transistor T2 are turned on, the data signal Di transferred from the data line DLi may be transferred to the first electrode of the first transistor T1. When at least one selected from the enable transistor ENT and the second transistor T2 is turned off, the data signal Di transferred from the data line DLi may not be transferred to the first electrode of the first transistor T1.

The third transistor T3 includes a first electrode connected to the gate electrode of the first transistor T1, a second electrode connected to the second electrode of the first semiconductor transistor T1, and a gate electrode connected to the scan line GCLj. The third transistor T3 may be turned on in response to the scan signal GCj transferred via the scan line GCLj to connect the gate electrode and the second electrode of the first transistor T1 to each other to diode-connect the first transistor T1.

The fourth transistor T4 includes a first electrode connected to the gate electrode of the first transistor T1, a second electrode connected to the third voltage line VL3 to which the first initialization voltage VINT1 is transferred, and a gate electrode connected to the scan line GILj. The fourth transistor T4 may be turned on in response to the scan signal GIj transferred via the scan line GILj to transfer the first initialization voltage VINT1 to the gate electrode of the first transistor T1 to perform an initialization operation of initializing the voltage of the gate electrode of first transistor T1.

The fifth transistor T5 includes a first electrode connected to the first driving voltage line VL1, a second electrode connected to the first electrode of the first transistor T1, and a gate electrode connected to the light emission control line EMLj.

The sixth transistor T6 includes a first electrode connected to the second electrode of the first transistor T1, a second electrode connected to the anode of the light-emitting element ED, and a gate electrode connected to the light-emitting control line EMLj.

The fifth transistor T5 and the sixth transistor T6 may be simultaneously turned on according to the light emission signal EMj transferred via the light emission control line EMLj, and the first driving voltage ELVDD may be compensated through the diode-connected first transistor T1 and transferred to the light emitting element ED.

The seventh transistor T7 includes a first electrode connected to the second electrode of the sixth transistor T6, a second electrode connected to the fourth voltage line VL4, and a gate electrode connected to the scan line GWLj+1. The seventh transistor T7 is turned on according to the scan signal GWj+1 transferred via the scan line GWLj+1 to bypass the current of the anode of the light-emitting element ED to the fourth voltage line VL4.

One end of the capacitor Cst is connected to the gate electrode of the first transistor T1, and the other end is connected to the first driving voltage line VL1.

The light-emitting element ED is electrically connected to the second electrode of the first transistor T1 via the sixth transistor T6. A cathode of the light-emitting element ED may be connected to the second driving voltage line VL2 that transfers the second driving voltage ELVSS. The structure of the pixel PX according to an embodiment is not limited to the structure illustrated in FIG. 7, and the number and connection relationships of transistors and capacitors in one pixel PX may be variously modified. In addition, the scan lines GWLj, GCLj, GILj and GWLj+1 connected to the second, third, fourth and seventh transistors T2, T3, T4 and T7 are merely examples, and other scan signals may be transferred to these transistors. In another embodiment, for example, the seventh transistor T7 may be connected to the scan line GCLj instead of the scan line GWLj+1.

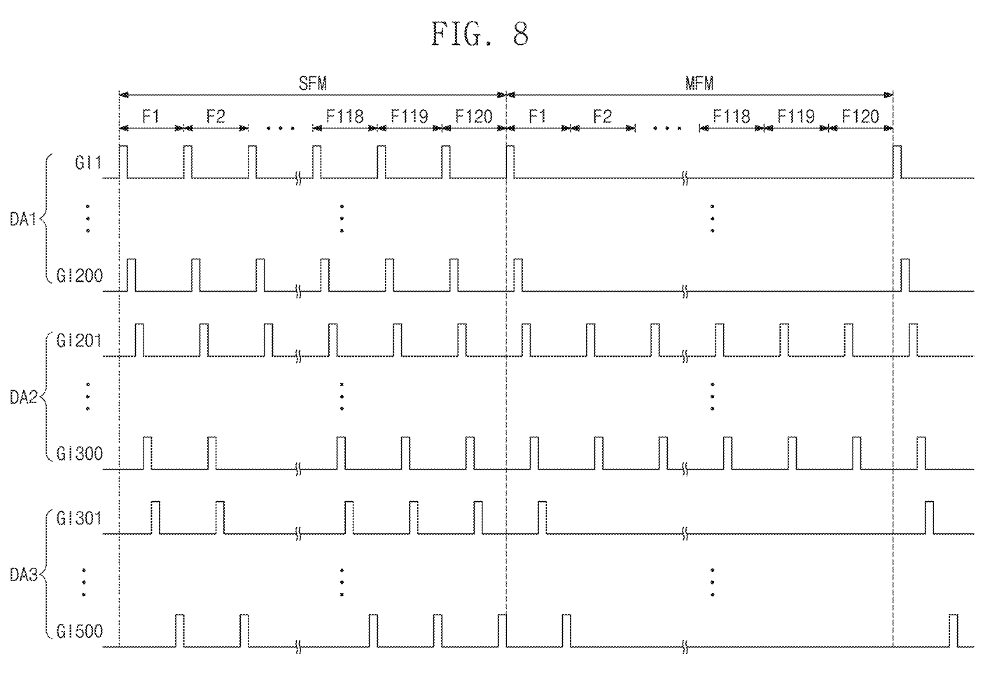

FIG. 8 illustrates scan signals GI1 to GI500 in the single frequency mode SFM and the multi-frequency mode MFM.

Although 500 scan signals GI1 to GI500 are illustrated in FIG. 8 as an example, the present disclosure is not limited thereto. The number of the scan signals GI1 to GI500 may be variously changed according to a size, resolution, and the like of the display panel DP.

Referring to FIGS. 1, 6, and 8, in an embodiment, the frequency of the scan signals GI1 to GI500 in the single frequency mode SFM is 120 Hz. During the single frequency mode SFM, the scan signals GI1 to GI500 may be sequentially activated to a high level in each of the first frame F1 to the 120th frame F120.

In an embodiment, among the scan signals GI1 to GI500 during the multi-frequency mode MFM, the scan signals GI1 to GI200 may correspond to the first display area DA1 of the electronic device 10, the scan signals GI201 to GI300 may correspond to the second display area DA2, and the scan signals GI301 to GI500 may correspond to the third display area DA3.

During the multi-frequency mode MFM, the scan signals GI1 to GI200 and GI301 to GI500 may be sequentially activated to the high level in the first frame F1. The scan signals GI1 to GI200 and GI301 to GI500 may be maintained at the high level during the second to 120th frames F2 to F120.

The scan signals GI201 to GI300 may be sequentially activated to the high level in each of the first frame F1 to the 120th frame F120. That is, the frequency of the scan signals GI1 to GI200 and GI301 to GI500 during the multi-frequency mode MFM is 1 Hz, and the frequency of the scanning signals GI201 to GI300 is 120 Hz.

Therefore, the frequency of the scan signals GI201 to GI300 corresponding to the second display area DA2 in which the moving image is displayed may be the second driving frequency (for example, 120 Hz), and the frequency of the scanning signals GI1 to GI200 and GI301 to GI500 corresponding to the first display area DA1 and the third display area DA3 in which the still image is displayed may be the first driving frequency (for example, 1 Hz). The display quality of the moving image may be maintained as the second display area DA2 in which the moving image is displayed is driven at the second driving frequency. Since the first display area DA1 and the third display area DA3 in which the still image is displayed are driven at the first driving frequency lower than the second driving frequency, power consumption may be reduced.

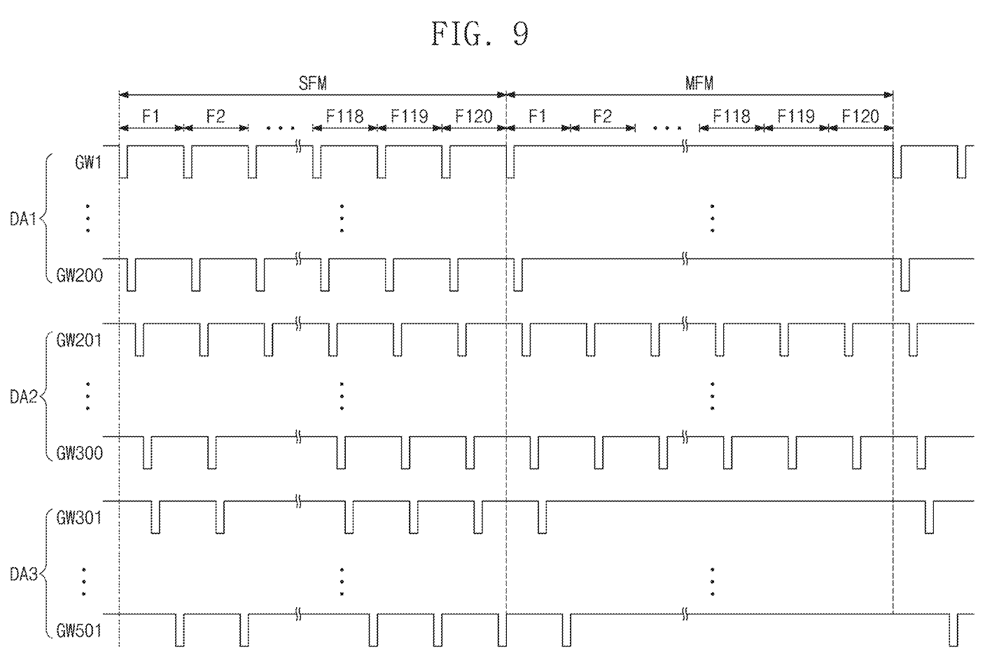

FIG. 9 illustrates scan signals GW1 to GW501 in the single frequency mode SFM and the multi-frequency mode MFM.

Although 501 scan signals GW1 to GW501 are illustrated in FIG. 9 as an example, the present disclosure is not limited thereto. The number of the scan signals GW1 to GW501 may be variously changed according to the size, resolution, and the like of the display panel DP.

Referring to FIGS. 3A, 6 and 9, in an embodiment, the frequency of the scan signals GW1 to GW501 in the single frequency mode SFM is 120 Hz.

During the single frequency mode SFM, the scan signals GW1 to GW501 may be sequentially activated to a low level in each of the first frame F1 to the 120th frame F120.

In an embodiment, among the scan signals GW1 to GW501 during the multi-frequency mode MFM, the scan signals GW1 to GW200 may correspond to the first display area DA1 of the electronic device 10, the scan signals GW201 to GW300 may correspond to the second display area DA2 of the electronic device 10, and the scan signals GW301 to GW501, may correspond to the third display area DA3 of the electronic device 10.

During the multi-frequency mode MFM, the scan signals GW1 to GW200 and GW301 to GW501 may be sequentially activated to the low level in the first frame F1. The scan signals GW1 to GW200 and GW301 to GW501 may be maintained at the high level during the second to 120th frames F2 to F120.

The scan signals GW201 to GW300 may be sequentially activated at the low level in each of the first frame F1 to the 120th frame F120. That is, during the multi-frequency mode MFM, the frequency of the scan signals GW1 to GW200 and GW301 to GW501 is 1 Hz, and the frequency of the scanning signals GW201 to GW300 is 120 Hz.

Therefore, the frequency of the scan signals GW201 to GW300 corresponding to the second display area DA2 in which the moving image is displayed may be the second driving frequency (for example, 120 Hz), and the frequency of the scanning signals GW1 to GW200 and GW301 to GW501 corresponding to the first display area DA1 and the third display area DA3 in which the still image is displayed may be the first driving frequency (for example, 1 Hz). The display quality of the moving image may be maintained as the second display area DA2 in which the moving image is displayed is driven at the second driving frequency. Since the first display area DA1 and the third display area DA3 in which the still image is displayed are driven at a first driving frequency lower than the second driving frequency, power consumption may be reduced.

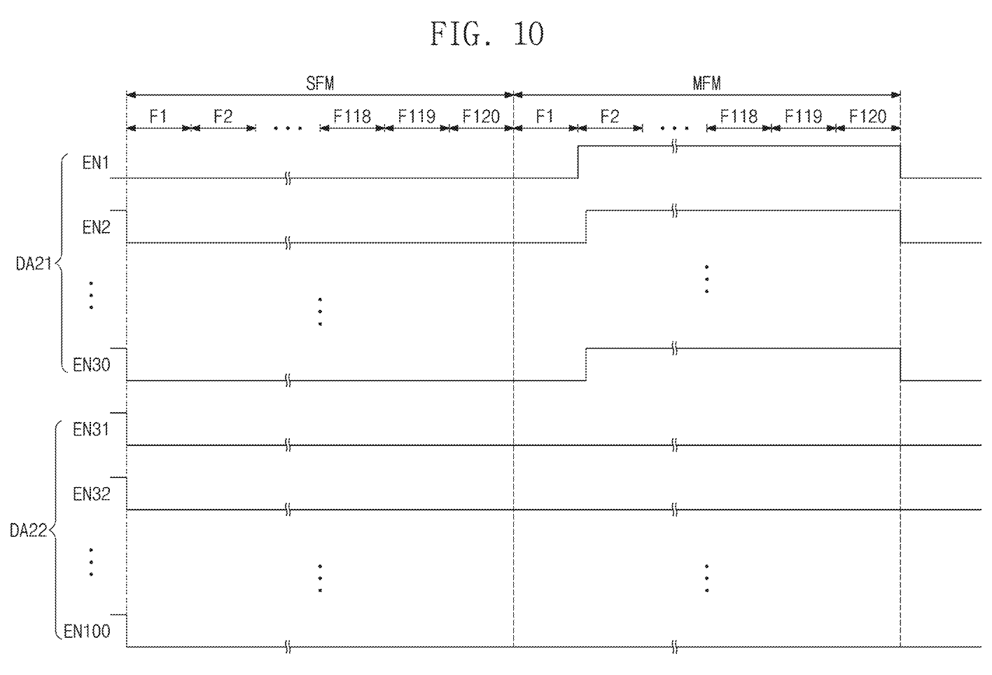

FIG. 10 illustrates enable signals EN1 to EN100 in the single frequency mode SFM and the multi-frequency mode MFM.

Although 100 enable signals EN1 to EN100 are illustrated in FIG. 10 as an example, the present disclosure is not limited thereto. The number of enable signals EN1 to EN100 may be variously changed according to the size, resolution, and the like of the display panel DP.

Referring to FIGS. 3A, 3B, 6, 7 and 10, in an embodiment, the enable signals EN1 to EN100 are maintained at the low level in the single frequency mode SFM.

The enable transistor ENT in the pixel PX may be maintained in a turned-on state while the enable signals EN1 to EN100 are maintained at the low level. Therefore, the data signals D1 to Dm transferred via the data lines DL1 to DLm during the single frequency mode SFM may be transferred to the first electrode of the first transistor T1 via the second transistor T2 of each of the pixels PX. In an embodiment, enable signals EN1 to EN100 correspond to data signals D1 to Dm, respectively. In an embodiment, each of the enable signals EN1 to EN100 may be at an active level (that is, the low level) when the data signals D1 to Dm are respectively provided from the data driver circuit 200 to the data lines DL1 to DLm.

In an embodiment, during the multi-frequency mode MFM, the enable signals EN1 to EN30 among the enable signals EN1 to EN100 correspond to the still image display area DA21 of the electronic device 10, and the enable signals ENT31 to EN100 correspond to a moving image display area DA22 of the electronic device 10.

In the first frame F1 of the multi-frequency mode MFM, the enable signals EN1 to EN100 are all at the low level. The enable transistor ENT in the pixel PX may be maintained in the turned-on state while the enable signals EN1 to EN100 are maintained at the low level.

As illustrated in FIG. 9, even when the first display area DA1 and the third display area DA3 are driven at the first driving frequency, the scan signals GW1 to GW501 are sequentially activated at the low level in the first frame F1. When the enable signals EN1 to EN100 are at the low level in the first frame F1 of the multi-frequency mode MFM, the data signals D1 to Dm transferred via the data lines DL1 to DLm may be transferred to the first electrode of the first transistor T1 via the second transistor T2 of each of the pixels PX as the scan signals GW1 to GW501 are sequentially activated to the low level.

In the second to 120th frames F2 to F120 of the multi-frequency mode MFM, the enable signals EN1 to EN30 corresponding to the still image display area DA21 are at the high level, and the enable signals ENT31 to EN100 corresponding to the moving image display area DA22 are maintained at the low level.

Pixels PX of the first display area DA1, the still image display area DA21 of the second display area DA2 and the third display area DA3 are not updated with a new data signal in the second to 120th frames F2 to F120. The enable transistor ENT is maintained in a turned-off state while the enable signals EN1 to EN30 are at the high level. The data signal Di cannot be transferred to the first electrode of the first transistor T1 while the enable transistor ENT is maintained in the turned-off state.

In an embodiment, the data driving circuit 200 does not output data signals (referred to as D1 to D30) corresponding to the enable signals EN1 to EN30 while the enable signals ENT1 to EN30 are maintained at the high level. Therefore, power consumed in the data driving circuit 200 can be minimized.

When the enable signals EN31 to EN100 corresponding to the moving image display area DA22 are maintained at the low level in the second to 120th frames F2 to F120 of the multi-frequency mode MFM, the enable transistor ENT in the pixel PX may be maintained in the turned-on state.

As illustrated in FIG. 9, in the second to 120th frames F2 to F120 of the multi-frequency mode MFM, as the scan signals GW201 to GW300 corresponding to the second display area DA2 sequentially transition to the low level and the enable signals EN31 to EN100 are maintained at the low level, the data signals (referred to as D31 to D100) transferred via the data lines (referred to as DL31 to DL100) corresponding to the enable signals ENT31 to EN100 may be transferred to the first electrode of the first transistor T1 via the enable transistor ENT and the second transistor T2 in the pixels PX. Therefore, an image may be displayed in the moving image display area DA22 in the second to 120th frames F2 to F120 of the multi-frequency mode MFM.

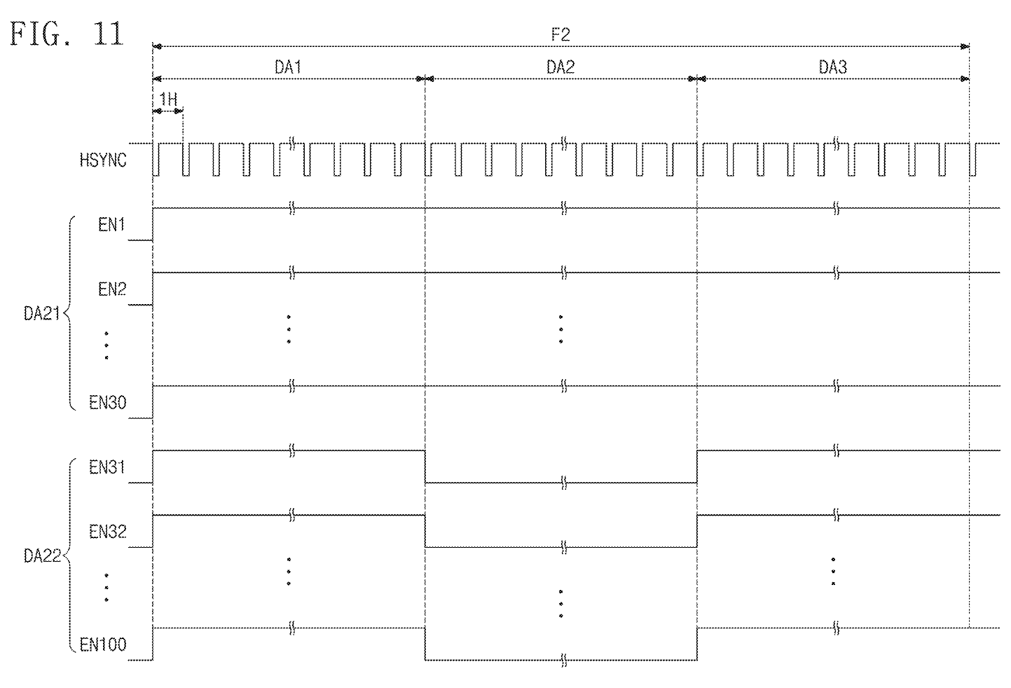

FIG. 11 is a signal timing diagram illustrating enable signals EN1 to EN100 according to an embodiment of the present disclosure.

FIG. 11 illustrates a horizontal synchronization signal HSYNC and the enable signals EN1 to EN100 in the second frame F2 in the multi-frequency mode. In an embodiment, the horizontal synchronization signal HSYNC may be a signal included in the data control signal DCS output from the driving controller 100. One horizontal period 1H of the horizontal synchronization signal HSYNC may indicate a time interval in which data signals are provided to the pixels PX disposed in one row of the display panel DP.

The second frame F2 in the multifrequency mode may be the same frame as the second frame F2 of the multifrequency mode MFM illustrated in FIG. 9. That is, the first display area DA1 and the third display area DA3 are driven at a first driving frequency, and the second display area DA2 is driven at a second driving frequency.

Although only the enable signals EN1 to EN100 of the second frame F2 are illustrated in FIG. 11 as an example, the enable signals ENT1 to EN100 in the third to 120th frames F3 to F120 may have the same signal waveform as the second frame F2, respectively.

The enable signals EN1 to EN100 may be maintained at the high level while the pixels PX disposed in the first display area DA1 and the third display area DA3 of the electronic device 10 are driven.

While the pixels PX disposed in the still image display area DA21 of the electronic device 10 are driven, the enable signals EN1 to EN30 are at the high level, and while the pixels PX disposed in the moving image display area DA22 of the electronic device 10 are driven, the enable signals EN31 to EN100 are at the low level.

In the embodiment shown in FIG. 10, the enable signals EN31 to EN100 are maintained at the low level in the second to 120th frames F2 to F120.

In the embodiment illustrated in FIG. 11, the enable signals EN31 to EN100 are maintained at the low level only while the pixels PX disposed in the moving image display area DA22 in the second to 120th frames F2 to F120 are driven. Therefore, power consumed in the electronic device 10 can be further reduced.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An electronic device comprising:
a display panel including a plurality of pixels; and
a data driving circuit which provides a plurality of data signals to the plurality of pixels via a plurality of data lines, and provides a plurality of enable signals to the plurality of pixels via a plurality of enable lines,
wherein each of the plurality of pixels emits light in response to a corresponding data signal of the plurality of data signals when a corresponding enable signal of the plurality of enable signals is at an active level.

2. The electronic device of claim 1, wherein each of the plurality of pixels includes:
a first transistor including a first electrode, a second electrode and a gate electrode;
an enable transistor including a first electrode connected to a corresponding data line of the plurality of data lines, a second electrode, and a gate electrode which receives the corresponding enable signal of the plurality of enable signals;
a second transistor including a first electrode connected to the second electrode of the enable transistor, a second electrode connected to the first electrode of the first transistor, and a gate line which receives a scan signal; and
a light-emitting element electrically connected to the second electrode of the first transistor.

3. The electronic device of claim 2, wherein, when both the enable transistor and the second transistor are turned on, a data signal applied to the corresponding data line is transferred to the first electrode of the first transistor.

4. The electronic device of claim 1, wherein:
the plurality of enable signals respectively correspond to the plurality of data lines; and
when the corresponding data signal is transferred to a corresponding data line of the plurality of data lines, each of the plurality of enable signals is at an active level.

5. The electronic device of claim 1, wherein:
each of the plurality of data lines extends in a first direction and is spaced apart in a second direction intersecting the first direction; and
the display panel includes a still image display area and a moving image display area which are sequentially arranged in the second direction.

6. The electronic device of claim 5, wherein:
the data driving circuit provides the corresponding data signal to a pixel disposed in the still image display area among the plurality of pixels during a first frame; and
the data driving circuit does not provide the corresponding data signal to a pixel disposed in the still image display area among the plurality of pixels during a second frame.

7. The electronic device of claim 5, wherein, when the data driving circuit does not provide the corresponding data signal to a pixel disposed in the still image display area among the plurality of pixels, the data driving circuit maintains the corresponding enable signal provided to the pixel disposed in the still image display area at an inactive level.

8. The electronic device of claim 7, wherein, when the data driving circuit provides the corresponding data signal to a pixel disposed on the moving image display area among the plurality of pixels, the data driving circuit maintains the corresponding enable signal provided to the pixel disposed in the moving image display area at an active level.

9. The electronic device of claim 8, wherein the pixel disposed in the still image display area of the display panel is driven at a first driving frequency, and the pixel disposed in the moving image display area of the display panel is driven at a second driving frequency higher than the first driving frequency.

10. The electronic device of claim 5, wherein:
the display panel includes a first display area and a second display area which are sequentially arranged in the first direction;
the second display area includes the still image display area and the moving image display area; and
pixels disposed in the first display area and the still image display area of the display panel among the plurality of pixels are driven at a first driving frequency, and the pixels disposed in the moving image display area of the display panel among the plurality of pixels are driven at a second driving frequency higher than the first driving frequency.

11. An electronic device comprising:
a processor which provides an input image signal and a control signal; and
a display module which displays an image in a multi-frequency mode in response to the input image signal and the control signal,
wherein the display module comprises:
a display panel including a plurality of pixels;
a driving controller which outputs an output image signal and a data control signal in response to the input video signal and the control signal; and
a data driving circuit which provides a plurality of data signals to the plurality of pixels via a plurality of data lines, and provides a plurality of enable signals to the plurality of pixels via a plurality of enable lines, in response to the output image signal and the data control signal, and
wherein each of the plurality of pixels emits light in response to a corresponding data signal of the plurality of data signals when a corresponding enable signal of the plurality of enable signals is at an active level.

12. The electronic device of claim 11, wherein each of the plurality of pixels includes:
a first transistor including a first electrode, a second electrode and a gate electrode;
an enable transistor including a first electrode connected to a corresponding data line of the plurality of data lines, a second electrode, and a gate electrode which receives the corresponding enable signal of the plurality of enable signals;
a second transistor including a first electrode connected to the second electrode of the enable transistor, a second electrode connected to the first electrode of the first transistor, and a gate line which receives a scan signal; and
a light-emitting element electrically connected to the second electrode of the first transistor.

13. The electronic device of claim 12, wherein, when both the enable transistor and the second transistor are turned on, a data signal applied to the corresponding data line is transferred to the first electrode of the first transistor.

14. The electronic device of claim 11, wherein:
the plurality of enable signals respectively correspond to the plurality of data lines; and
when the corresponding data signal is transferred to a corresponding data line of the plurality of data lines, each of the plurality of enable signals is at an active level.

15. The electronic device of claim 11, wherein:
each of the plurality of data lines extends in a first direction and is spaced apart in a second direction intersecting the first direction; and
the display panel includes a still image display area and a moving image display area which are sequentially arranged in the second direction.

16. The electronic device of claim 15, wherein, when the data driving circuit does not provide the corresponding data signal to a pixel disposed in the still image display area among the plurality of pixels, the data driving circuit maintains the corresponding enable signal provided to the pixel disposed in the still image display area at an inactive level.

17. The electronic device of claim 16, wherein, when the data driving circuit provides the corresponding data signal to a pixel disposed in the moving image display area among the plurality of pixels, the data driving circuit maintains the corresponding enable signal provided to the pixel disposed in the moving image display area at an active level.

18. A pixel comprising:
a first transistor including a first electrode, a second electrode and a gate electrode;
an enable transistor including a first electrode connected to a data line which transfers a data signal, a second electrode, and a gate electrode which receives an enable signal;
a second transistor including a first electrode connected to the second electrode of the enable transistor, a second electrode connected to the first electrode of the first transistor, and a gate line which receives a scan signal; and
a light-emitting element electrically connected to the second electrode of the first transistor.

19. The pixel of claim 18, wherein, when the data signal is transferred to the data line, the enable signal is at an active level.

20. The pixel of claim 18, wherein, when both the enable transistor and the second transistor are turned on, the data signal is transferred to the first electrode of the first transistor.
